(19) United States
(12) Patent Application Publication
(10) Pub. No.: US 2003/0018536 A1
(43) Pub. Date: Jan. 23, 2003

(54) Reorder and default order mechanisms for a shopping cart of an e-commerce website

(75) Inventors: Thomas John Eggebraaten, Rochester, MN (US); Jeffrey Allen Prentice, Oronoco, MN (US)

Correspondence Address: MARTIN & ASSOCIATES, LLC, P O BOX 548, CARTHAGE, MO, 64836-0548, US

(73) Assignee: International Business Machines Corporation, Armonk, NY

(21) Appl. No.: 09/910,534

(22) Filed: Jul. 20, 2001

(51) Int. Cl. G06F 17/60

(52) U.S. Cl. 705/26

(57) ABSTRACT

A shopping cart on an e-commerce web site includes a reorder mechanism and a default order mechanism. The reorder mechanism causes all items that were in a previous order to be automatically added to the shopping cart. The default order mechanism causes all items in a defined default order to be automatically added to the shopping cart. The default order may be defined in any suitable way, including entering an order and selecting the order as default order, and entering order items directly into a default order. The reorder mechanism and default order mechanism of the preferred embodiments place one or more order items in the shopping cart. The user can then delete any of the order items, or may continue shopping, as desired. The preferred embodiments thus provide a shortcut to shopping when the same goods are repeatedly ordered.

### BACKGROUND OF THE INVENTION

1. Technical Field

This invention generally relates to e-commerce and more specifically relates to methods for ordering items from an e-commerce web site.

2. Background Art

Since the dawn of the computer age, computer systems have evolved into extremely sophisticated devices, and computer systems may be found in many different settings. The widespread proliferation of computers prompted the development of computer networks that allow computers to communicate with each other. With the introduction of the personal computer (PC), computing became accessible to large numbers of people. Networks for personal computers were developed that allow individual users to communicate with each other.

One significant computer network that has recently become very popular is the Internet. The Internet grew out of this proliferation of computers and networks, and has evolved into a sophisticated worldwide network of computer system resources commonly known as the “world-wide-web”, or WWW. A user at an individual PC (i.e., workstation) that wishes to access the Internet typically does so using a software application known as a web browser. A web browser makes a connection via the Internet to other computers known as web servers, and receives information from the web servers that is rendered to the user's workstation. Information transmitted from the web server to the web browser is generally formatted using a specialized language called Hypertext Markup Language (HTML) and is typically organized into pages known as web pages.

Online merchants have discovered the value of selling their goods via the Internet. Many allow buyers to place goods in a virtual “shopping cart”, then when the buyer is prepared to finalize the purchase, they proceed to the “checkout.” At this stage, all of the items in the buyer's shopping cart are displayed with their prices, tax, shipping and handling, and a total amount due is shown to the buyer. The buyer can then enter credit card information, and pressing a “submit” button sends the credit card information to the merchant, which then authenticates the credit card and receives an authorization for the sale.

In Business to Business (B2B) applications, it is very common for buyers to buy the same or similar products on a regular basis. With known e-commerce web sites, the buyer must locate and select the items to be purchased in order to place them in their shopping cart. Thus, if a buyer needs to buy 30 different order items each month from the same vendor via the vendor's e-commerce web site, the buyer has to locate each order item and select each order item to place the order item in the shopping cart. This is a tedious and inefficient process. Without a mechanism and method that allows a buyer to easily place a group of goods in a shopping cart, the efficiency of e-commerce transactions will be greatly impaired.

### DISCLOSURE OF INVENTION

According to the preferred embodiments, a shopping cart on an e-commerce web site includes a reorder mechanism and a default order mechanism. The reorder mechanism causes all items that were in a previous order to be automatically added to the shopping cart. The default order mechanism causes all items in a defined default order to be automatically added to the shopping cart. The default order may be defined in any suitable way, including entering an order and selecting the order as the default order, and entering order items directly into a default order. The reorder mechanism and default order mechanism of the preferred embodiments place one or more order items in the shopping cart. The buyer can then delete any of the order items, or may continue shopping, as desired. The preferred embodiments thus provide a shortcut to shopping when the same goods are repeatedly ordered.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a prior art configuration for a buyer to shop on-line using a web client that interacts with an e-commerce application on a web server;

FIG. 2 is a block diagram of an apparatus in accordance with the preferred embodiments that shows the reorder mechanism and the default order mechanism as part of an e-commerce application;

FIG. 3 is a block diagram of a web server in accordance with the preferred embodiments;

FIG. 4 is a flow diagram of a method in accordance with the preferred embodiments;

FIG. 5 is a flow diagram of a first method in accordance with the preferred embodiments for defining a default order;

FIG. 6 is a flow diagram of a second method in accordance with the preferred embodiments for defining a default order; and

FIG. 7 is a display showing a shopping cart that incorporates the reorder mechanism and default order mechanism of the preferred embodiments.

### BEST MODE FOR CARRYING OUT THE INVENTION

Overview

The method and apparatus of the present invention has particular applicability to shopping on-line via the Internet. For those individuals who are not familiar with the Internet, a brief overview of relevant Internet concepts is presented here.

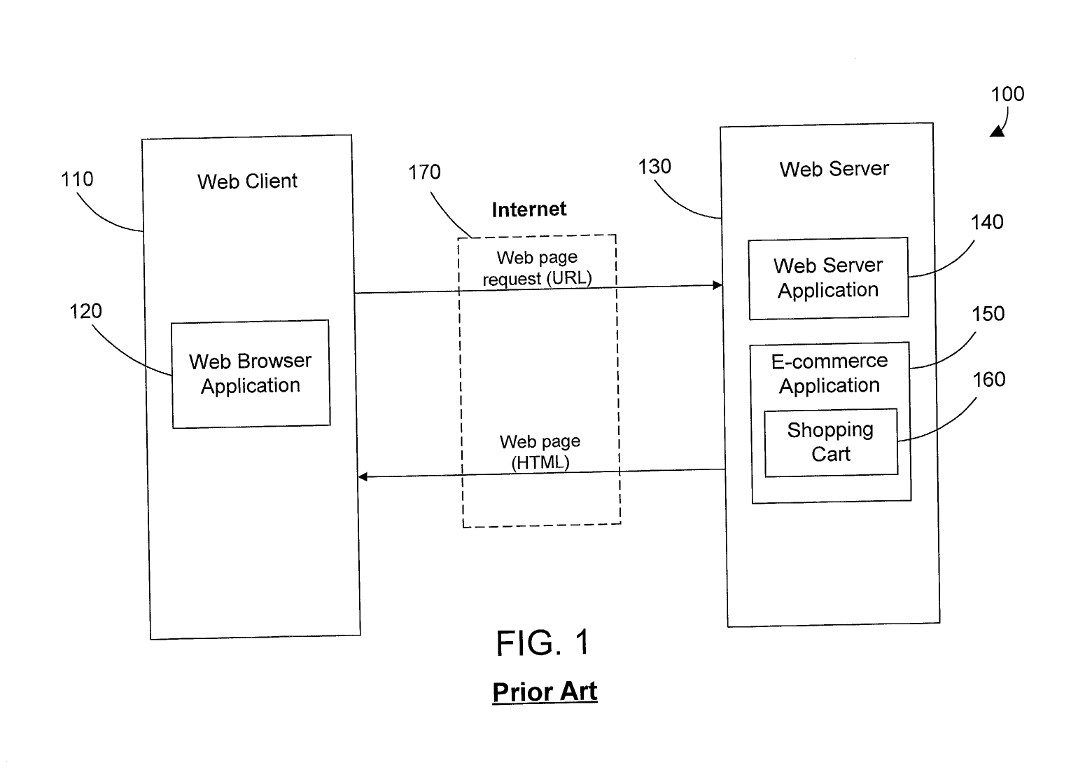

An example of a typical Internet connection is shown by the apparatus 100 in FIG. 1. A user that wishes to access information on the Internet 170 typically has a computer workstation 110 (referred to as a “web client”) that executes an application program known as a web browser 120. Under the control of web browser 120, web client workstation 110 sends a request for a web page over the Internet 170. Each web server on the Internet has a known address, termed the Uniform Resource Locator (URL), which the web browser uses to connect to the appropriate web server. Because web server 130 can contain more than one web page, the user will also specify in the address which particular web page he or she wants to view on web server 130. A web server computer system 130 executes a web server application 140, monitors requests, and services requests for which it has responsibility. When a request specifies web server 130, web server application 140 generally accesses a web page corresponding to the specific request, and transmits the web page to the web browser 120 on the user's workstation 110. Known web browsers include Netscape Communicator and Microsoft Internet Explorer.

A web page may contain various types of data, including text, graphics and other forms of information, collectively known as MIME data. Most web pages include visual data that is intended to be displayed on the monitor of user workstation 110. Web pages are generally written in Hypertext Markup Language (HTML) or as Java server pages (.jsp files). When web server 130 receives a web page request, it will send the requested web page across the Internet 170 to the requesting web browser 120. Web browser 120 understands HTML and Java and interprets the web page and outputs the web page to the monitor (or display) of user workstation 110. This web page displayed on the user's screen may contain any suitable MIME data, including text, graphics, audio elements, video elements, and links (which reference addresses of other web pages). The user can invoke other web pages by clicking on these links using a mouse or other pointing device. This entire system of web pages with links to other web pages on other servers across the world is known as the “World Wide Web”.

Many web servers include one or more e-commerce applications, such as e-commerce application 150 in FIG. 1. Most e-commerce applications include a “shopping cart” 160, which is a virtual container for items that the buyer may want to purchase. A buyer may select order items, which are then added to the shopping cart. The buyer may review the contents of the shopping cart, and may delete order items or may change quantities as required. In this manner the buyer may “shop” on-line in much the same way the buyer shops in a real store, adding items to a shopping cart, putting items in the shopping cart back on the shelf if the buyer changes his or her mind, adding more of the same item to the shopping cart if needed, etc. When the buyer is ready to place an order for the items in the shopping cart, the buyer clicks on a “checkout” button, which creates an order with the order items in the shopping cart.

The remainder of this specification describes how the preferred embodiments simplify the buyer's task of buying items on-line when the buyer places orders for the same items on a regular basis.

### DETAILED DESCRIPTION

The preferred embodiments provide a reorder mechanism and a default order mechanism that speed a buyer's job of buying the same items again and again. The reorder mechanism places all of the order items in a previous order into the current shopping cart. The default order mechanism places all of the items in a defined default order into the current shopping cart. Once these order items are automatically placed in the shopping cart, they may be deleted or their quantities may be changed as required.

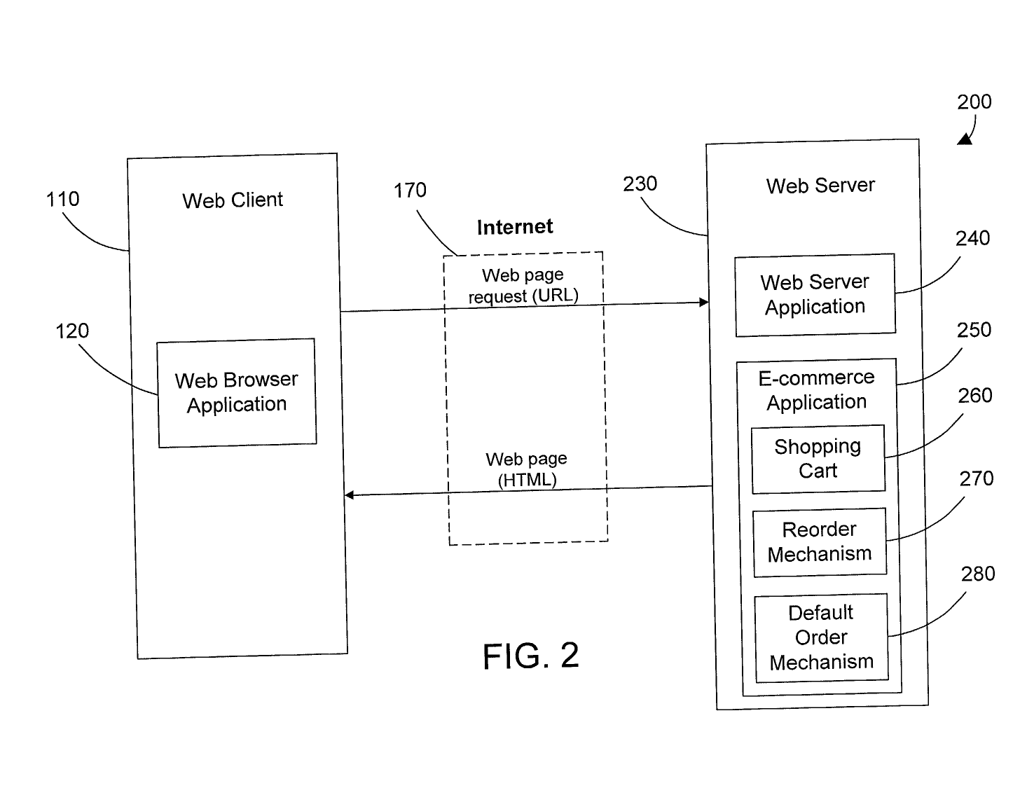

Referring to FIG. 2, an apparatus 200 is similar in many respects to prior art apparatus 100 of FIG. 1. Note, however, that web server 230 in apparatus 200 includes a web server application 240, and an e-commerce application 250 that contains not only a shopping cart 260, but also contains a reorder mechanism 270 and a default order mechanism 280. The reorder mechanism 270 automatically places all order items in a previous order into the shopping cart 260. The default order mechanism 280 automatically places all order items in a defined default order into the shopping cart 260. Once the reorder mechanism 270 or default order mechanism 280 place order items into the shopping cart 260, these order items may be deleted or their quantity changed, as is known with prior art shopping carts.

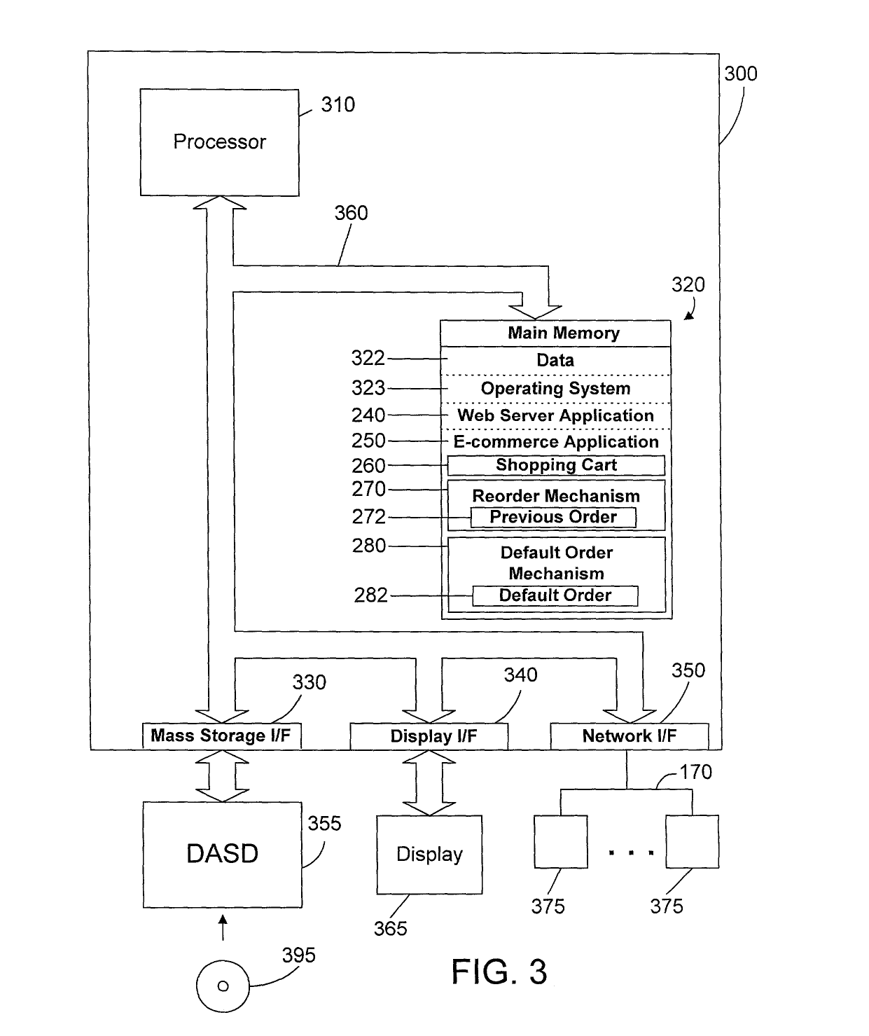

Referring to FIG. 3, one specific implementation of an apparatus in accordance with the preferred embodiments is an IBM iSeries 400 computer system 300. Computer system 300 is one suitable example of web server computer system 230 in FIG. 2. Computer system 300 comprises a processor 310 connected to a main memory 320, a mass storage interface 330, a display interface 340, and a network interface 350. These system components are interconnected through the use of a system bus 360. Mass storage interface 330 is used to connect mass storage devices (such as a direct access storage device 355) to computer system 300. One specific type of direct access storage device is a CD ROM drive, which may store data to and read data from a CD ROM 395.

Main memory 320 in accordance with the preferred embodiments contains data 322, an operating system 323, a web server application 240, and an e-commerce application 250. E-commerce application 250 includes a shopping cart 260, a reorder mechanism 270, and a default order mechanism 280. Shopping cart 260 holds order items for a buyer until the buyer is ready to finalize the order. Reorder mechanism 270 is used to automatically place all the order items in a previous order 272 into the shopping cart 260. In the preferred embodiments, a previous order 272 may be any order that has been placed, but is most useful when the previous order 272 is the most recent order placed by the buyer. Default order mechanism 280 is used to automatically place all the order items in a default order 282 into the shopping cart 260. The default order 282 may be created in any suitable way. One suitable way is for a buyer to create an order, then save the order as a default order. Another suitable way is for a buyer to enter an editor that defines the default order, then select order items for inclusion in the default order. Of course, there are other ways to create a default order 282, and the preferred embodiments expressly extend to any suitable way to create a default order 282.

In FIG. 3, reorder mechanism 270 and default order mechanism 280 are shown as functions that are separate from the shopping cart 260. Note, however, that the preferred embodiments extend to a shopping cart that includes the reorder mechanism 270 and default order mechanism 280.

Computer system 300 utilizes well known virtual addressing mechanisms that allow the programs of computer system 300 to behave as if they only have access to a large, single storage entity instead of access to multiple, smaller storage entities such as main memory 320 and DASD device 355. Therefore, while data 322, operating system 323, web server application 240, and e-commerce application 250 are shown to reside in main memory 320, those skilled in the art will recognize that these items are not necessarily all completely contained in main memory 320 at the same time. It should also be noted that the term “memory” is used herein to generically refer to the entire virtual memory of computer system 300.

Data 322 represents any data that serves as input to or output from any program in computer system 300. Operating system 323 is a multitasking operating system known in the industry as OS/400; however, those skilled in the art will appreciate that the spirit and scope of the present invention is not limited to any one operating system. Web server application 240 is a computer program that services requests for web pages from web browsers and renders web pages to the web browsers that request them, similar in many ways to web server application 140 in FIG. 1.

Processor 310 may be constructed from one or more microprocessors and/or integrated circuits. Processor 310 executes program instructions stored in main memory 320. Main memory 320 stores programs and data that processor 310 may access. When computer system 300 starts up, processor 310 initially executes the program instructions that make up operating system 323. Operating system 323 is a sophisticated program that manages the resources of computer system 300. Some of these resources are processor 310, main memory 320, mass storage interface 330, display interface 340, network interface 350, and system bus 360.

Although computer system 300 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 310. However, those skilled in the art will appreciate that the present invention applies equally to computer systems that simply use I/O adapters to perform similar functions.

Display interface 340 is used to directly connect one or more displays 365 to computer system 300. Display 365 may be simple display devices or fully programmable workstations, and are used to allow system administrators to communicate with computer system 300.

Network interface 350 allows computer system 300 to send and receive data to and from any network the computer system may be connected to. This network may be a local area network (LAN), a wide area network (WAN), or more specifically the Internet 170. Suitable methods of connecting to the Internet include known analog and/or digital techniques, as well as networking mechanisms that are developed in the future. Many different network protocols can be used to implement a network. These protocols are specialized computer programs that allow computers to communicate across a network. TCP/IP (Transmission Control Protocol/Internet Protocol), used to communicate across the Internet, is an example of a suitable network protocol.

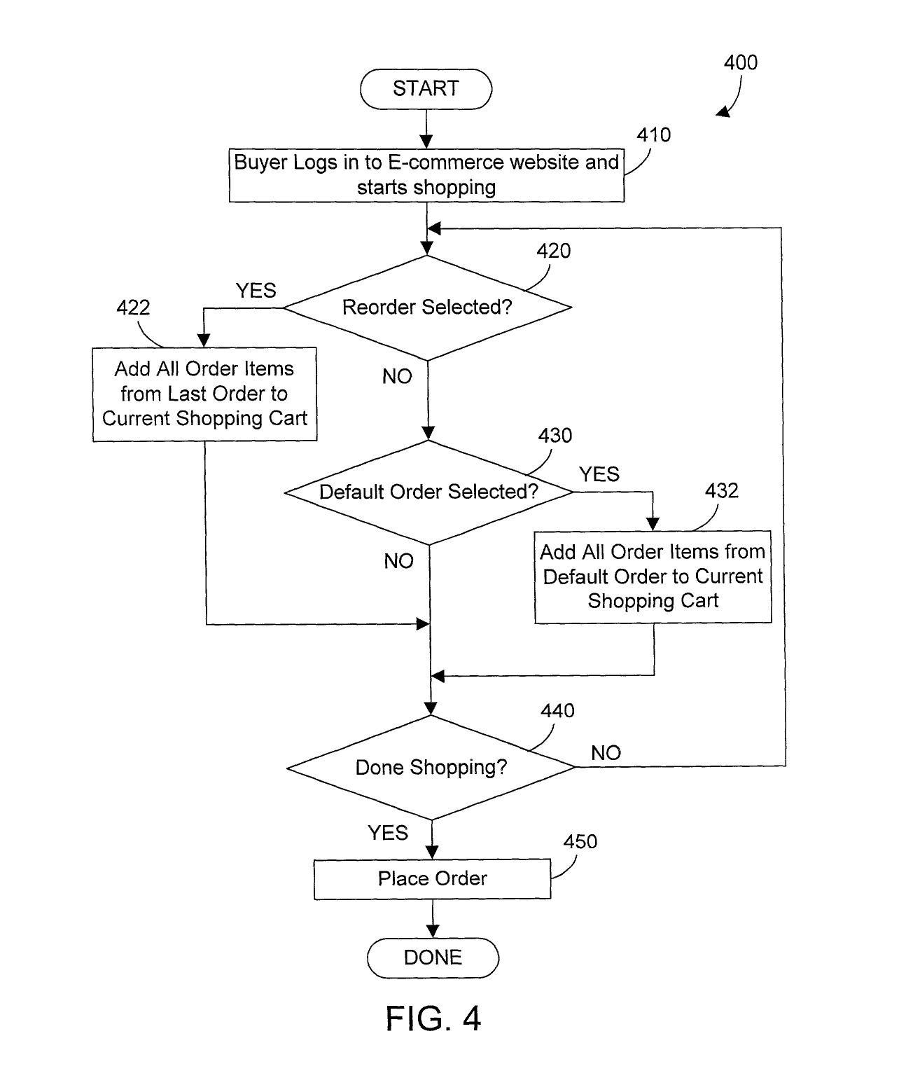

Referring now to FIG. 4, a method 400 in accordance with the preferred embodiments begins when a buyer logs in to an e-commerce website and starts shopping (step 410). We assume that the web pages displayed to the user (or buyer) while shopping include buttons or other activation mechanisms (such as a drop-down list) that may be selected by the user to activate the reorder mechanism 270 and the default order mechanism 280. If the user selects an activation mechanism that corresponds to the reorder mechanism (step 420=YES), the reorder mechanism reads the order items from the previous order 272 and places all of the order items from the previous order 272 into the current shopping cart (step 422). If reorder is not selected (step 420=NO), but the default order is selected by the buyer (step 430=YES), the default order mechanism reads the default order and adds all order items from the default order to the current shopping cart (step 432). Once the buyer is done shopping (step 440=YES), the order is placed (step 450), and method 400 is done. If the buyer is not done shopping (step 440=NO), method 400 loops back to step 420 and continues.

In the preferred embodiments, the reorder mechanism and the default order mechanism simply add items from a previous order or from a default order to a shopping cart. The user is then left to use known shopping cart mechanisms to add more order items, delete unwanted order items, or to change quantities of order items. Note, however, that the reorder mechanism and default order mechanism may include some user-defined options that determine which order items are added to the shopping cart. For example, the reorder mechanism may display a list of order items that were in a previous order, and allow a user to select which of these order items to add to the shopping cart. In addition, the reorder mechanism may prompt the user to select whether or not to include the quantities from the previous order. If the user selects to not include the quantities, each selected order item would be added to the shopping cart with a quantity of one. The user could then modify the quantity using the shopping cart mechanisms. Similar features and functions could be supplied for the default order mechanism. The preferred embodiments expressly extend to any mechanism or method for adding any order item in any previous order or in a default order to a shopping cart.

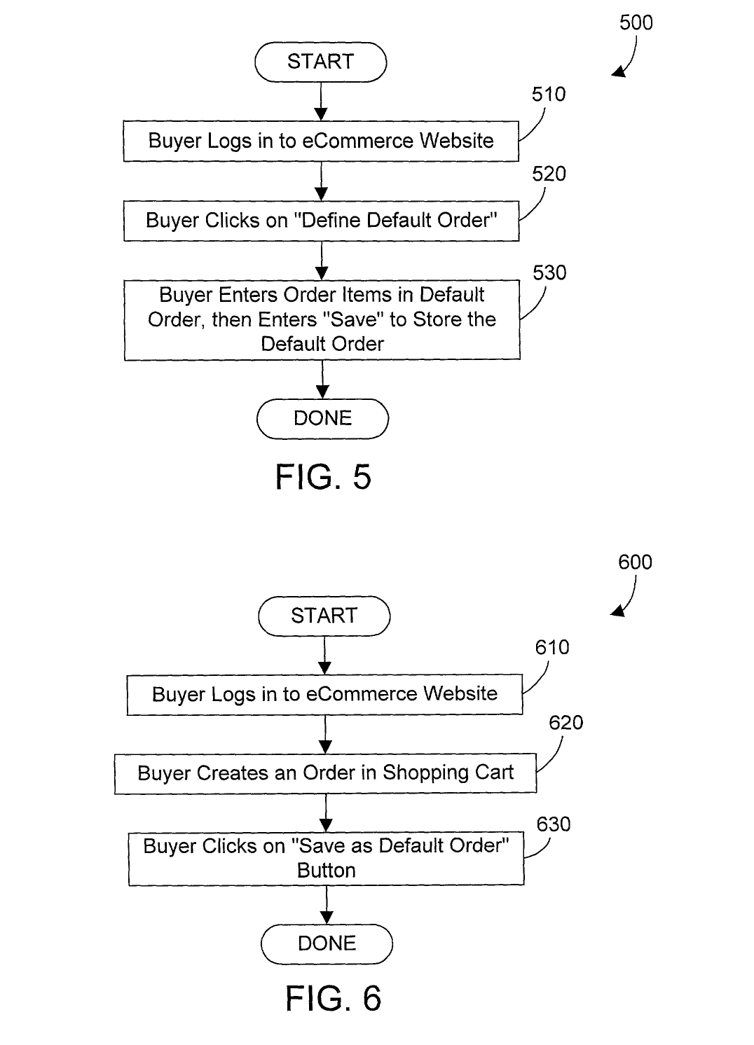

FIGS. 5 and 6 are flow diagrams of two different methods for defining a default order 282 as shown in FIG. 3. Method 500 of FIG. 5 starts by the buyer logging into the e-commerce website (step 510). The buyer clicks on a “Define Default Order” button or other function (step 520). In response, the buyer is presented with a “shopping cart” that represents the default order. The buyer can then place order items in the default order the same way that the buyer normally places order items in a shopping cart, then selects a “save” function to save the default order (step 530).

Method 600 of FIG. 6 begins when a buyer logs in to an e-commerce website (step 610). The buyer creates an order in the shopping cart (step 620), the clicks on a button or other function that saves the current order as the default order (step 630). Note that another suitable method for defining a default order is to present the user with a list of previous orders, and allow the user to select one of the previous orders as the default order. The user could then edit the default order as needed, and save the result for future use.

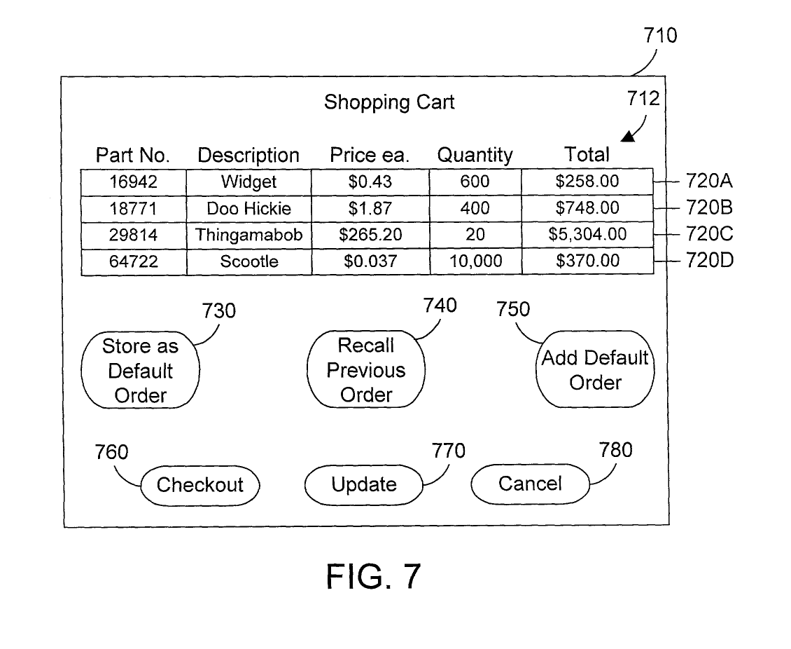

A user interface display window 710 is shown in FIG. 7 that illustrates how the reorder and default order mechanisms may be activated by a buyer. Display window 710 shows the contents of the shopping cart in the form of entries 720 in a shopping cart list 712, as shown by 720A-720D in FIG. 7. For this specific example, each entry 720 includes a part number, description, price each, quantity, and total price. The buyer may click on the “Recall Previous Order” button 740 to retrieve a list of previous orders from which the user may select one or more previous orders. The order items from the selected previous order(s) are then added to list 712 in the shopping cart. In the alternative, instead of “Recall Previous Order” button 740, a different “Recall Last Order” button could be provided that automatically places all order items from the most recent order into the shopping cart list 712.

Clicking on the “Add Default Order” button 750 results in all order items that are in the default order being added to the shopping cart list 712. Note that the default order may be selected from a list of defined orders, allowing different defaults to be used, depending on the circumstances. At any time that there is one or more entries 720 in list 712, the user may click on the “Store as Default Order” button 730, which stores the order items in the shopping cart list 712 as the default order (or as a default order in a list of default order candidates). A checkout button 760 is also provided to allow the buyer to check out (i.e., place the order for the items in the shopping cart list 712). An update button 770 is provided to change the quantity of an order item in the shopping cart list 712, or to delete an order item whose quantity has been changed to zero. A cancel button 770 is also provided to allow a user to close window 710 and keep shopping.

A shopping cart that includes a reorder mechanism and a default order mechanism as described in the preferred embodiments above may be implemented using IBM's WebSphere Commerce Suite version 4.1, which provides commands that perform various business processes such as copying an order, canceling an order, and displaying the contents of an order. For details regarding the WebSphere Commerce Suite, please see www-4.ibm.com/software/webservers/commerce. In one suitable implementation using WebSphere Commerce Suite, the shopping cart is implemented as an order item list and the OrderItem and Order commands are used to implement the functions of the reorder mechanism discussed above. In this implementation, the OrderCopy command is used to copy an existing order (specifically, an already-placed order) to the shopping cart to perform the function of the reorder mechanism. The OrderDisplay command displays the current contents of the shopping cart. The OrderItemUpdate command updates order items in the shopping cart, and the OrderItemMultiple command adds or deletes products from the shopping cart.

One suitable implementation of the default order mechanism of the preferred embodiments uses the WebSphere Commerce Suite to implement the shopping cart as an order item list and use the OrderItem and Order commands to manipulate order items. The OrderItemMultiple command is used to create the default order initially as well as add, delete, and update products in the default order. When the user wants the order items from a default order added to the current order, the OrderCopy command is used to copy the order items from the default order to the shopping cart. The customer can continue to modify the shopping cart (add/delete order items, change quantities, etc.) using the OrderItemMultiple and OrderItemUpdate commands until the order is placed.

The preferred embodiments greatly simplify a buyer's task of ordering items that are ordered again and again. By selecting a previous order or a default order, a buyer can automatically place order items in the shopping cart. This works even for a large number of order items. If a previous order has dozens of order items, all of these order items may be automatically added to the shopping cart by the user selecting the previous order using the reorder mechanism of the preferred embodiments. Similarly, if a default order has dozens of order items, all of these order items may be automatically added to the shopping cart by the user selecting the default order using the default order mechanism of the preferred embodiments. In this manner the job of ordering the same products is greatly simplified, which enhances the efficiency of e-commerce transactions.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
at least one previous order residing in the memory, each previous order including at least one order item;
an e-commerce application residing in the memory and executed by the at least one processor, the e-commerce application including:
a shopping cart that may contain a plurality of order items; and
a reorder mechanism that automatically places all order items in a selected previous order in the shopping cart.

2. The apparatus of claim 1 wherein the selected previous order comprises the order that was most recently placed by a user of the e-commerce application.

3. An apparatus comprising:
at least one processor;
a memory coupled to the at least one processor;
a default order residing in the memory, the default order including at least one order item;
an e-commerce application residing in the memory and executed by the at least one processor, the e-commerce application including:
a shopping cart that may contain a plurality of order items; and
a default order mechanism that automatically places all order items in the default order in the shopping cart.

4. The apparatus of claim 3 wherein the default order is defined by a user defining an order and selecting the order as the default order.

5. The apparatus of claim 3 wherein the default order is defined by a user selecting at least one order item to add to the default order.

6. An apparatus comprising:
at least one processor;
a memory coupled to the at least one processor;
a previous order residing in the memory;
a default order residing in the memory;
an e-commerce application residing in the memory and executed by the at least one processor, the e-commerce application including:
a shopping cart that may contain a plurality of order items;
a reorder mechanism that automatically places all order items in the previous order in the shopping cart; and
a default order mechanism that automatically places all order items in the default order in the shopping cart.

7. The apparatus of claim 6 wherein the previous order comprises the order that was most recently placed by a user of the e-commerce application.

8. The apparatus of claim 6 wherein the default order is defined by a user defining an order and selecting the order as the default order.

9. The apparatus of claim 6 wherein the default order is defined by a user selecting at least one order item to add to the default order.

10. A method for a buyer to shop on an e-commerce web site, the method comprising the steps of:
placing a previous order that includes at least one order item with the e-commerce web site;
presenting a shopping cart to the buyer;
presenting an activation mechanism for a reorder mechanism to the buyer; and
when the buyer selects the activation mechanism for the reorder mechanism, automatically placing in the shopping cart all order items in the previous order.

11. The method of claim 10 wherein the previous order comprises the order that was most recently placed by the buyer on the e-commerce web site.

12. A method for a buyer to shop on an e-commerce web site, the method comprising the steps of:
(A) defining a default order that includes at least one order item;
(B) presenting a shopping cart to the buyer;
(C) presenting an activation mechanism for a default order mechanism to the buyer; and
(D) when the buyer selects the activation mechanism for the default order mechanism, automatically placing in the shopping cart all order items in the default order.

13. The method of claim 12 wherein step (A) comprises the steps of:
defining an order; and
selecting the order as the default order.

14. The method of claim 12 wherein step (A) comprises the step of:
selecting at least one order item to add to the default order.

15. A method for a buyer to shop on an e-commerce web site, the method comprising the steps of:
(A) placing a previous order comprising at least one order item with the e-commerce web site;
(B) defining a default order comprising at least one order item;
(C) presenting a shopping cart to the buyer;
(D) presenting an activation mechanism for a reorder mechanism to the buyer;
(E) presenting an activation mechanism for a default order mechanism to the buyer;
(F) when the buyer selects the activation mechanism for the reorder mechanism, automatically placing in the shopping cart all order items in the previous order; and
(G) when the buyer selects the activation mechanism for the default order mechanism, automatically placing in the shopping cart all order items in the default order.

16. The method of claim 15 wherein the previous order comprises the order that was most recently placed by the buyer.

17. The method of claim 15 wherein step (B) comprises the steps of:
defining an order; and
selecting the order as the default order.

18. The method of claim 15 wherein step (B) comprises the step of:
selecting at least one order item to add to the default order.

19. A computer-readable program product comprising:
a shopping cart that may contain a plurality of order items;
a reorder mechanism that automatically places all order items in a previous order in the shopping cart; and
computer-readable signal bearing media bearing the shopping cart and the reorder mechanism.

20. The program product of claim 23 wherein the computer-readable signal bearing media comprises recordable media.

21. The program product of claim 23 wherein the computer-readable signal bearing media comprises transmission media.

22. The program product of claim 23 further comprising a default order mechanism that automatically places all order items in the default order in the shopping cart, the signal bearing media bearing the default order mechanism.

23. A computer-readable program product comprising:
a shopping cart that may contain a plurality of order items; and
a default order mechanism that automatically places all order items in a defined default order in the shopping cart; and
computer-readable signal bearing media bearing the shopping cart and the default order mechanism.

24. The program product of claim 23 wherein the computer-readable signal bearing media comprises recordable media.

25. The program product of claim 23 wherein the computer-readable signal bearing media comprises transmission media.

26. The program product of claim 23 wherein the default order is defined by a user defining an order and selecting the order as the default order.

27. The program product of claim 23 wherein the default order is defined by a user selecting at least one order item to add to the default order.
